(19) United States
(12) Patent Application Publication
(10) Pub. No.: US 2006/0172054 A1
(43) Pub. Date: Aug. 3, 2006

(54) Process for mozzarella-type cheese

(75) Inventors: Tischa Carlys Inniss, Chicago, IL (US); Russell Allen Tietz, Evanston, IL (US); Pamela Lynn Guzowshi, Glenview, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 11/047,424

(22) Filed: Jan. 31, 2005

(51) Int. Cl. A23C 19/00

(52) U.S. Cl. 426/582

(57) ABSTRACT

The invention is directed to an improved process of producing mozzarella-type cheese. The process starts with a liquid dairy substrate that is cultured and coagulated. The coagulated dairy substrate is cut, and the curds are separated from the whey and collected to form a base curd. The base curd is blended with a farinaceous material. The base curd/farinaceous material blend is then cooked in a cooker or cooker/stretcher (preferably in a lay-down cooker). The cheese mass is then cooled to produce the mozzarella-type cheese. The blending of the farinaceous material with the base curd before cooking/stretching allows it to act as a fat mimetic, which imparts a product characteristic in reduced-fat or fat-free cheese resembling a full-fat product, such as improved mouthfeel. It also serves to improve moisture binding in the product and results in a firmer cheese which may be easier to shred, and produces a more homogenous product.

### FIELD OF THE INVENTION

The present invention is directed to cheese products. More particularly, the present invention is directed to an improved process for producing mozzarella-type cheese products, including natural mozzarella cheeses, and to the cheese products made by this process.

### BACKGROUND OF THE INVENTION

The conventional process for manufacturing mozzarella-type cheese products comprises pasteurizing cow, buffalo, or similar milk; acidifying the milk to convert it to a cheese milk; coagulating the cheese milk to obtain a coagulum comprised of curd and whey; cutting the coagulum and draining the whey therefrom, thereby leaving a cheese curd; heating, kneading, and stretching the cheese curd until it is a homogeneous fibrous mass of heated, unripened cheese; shaping the heated cheese; cooling the shaped cheese in cold brine; and removing the cooled cheese from the brine. The cooled product may be shredded into sizes more suitable for certain food applications, such as pizza toppings.

The heating, kneading, and stretching of the cheese curd is typically carried out in a piece of equipment called a mixer/cooker. U.S. Pat. No. 5,902,625 indicates that the addition of starch to cheese curd after completion of cooking and stretching of mozzarella cheeses has been indicated to obviate pizza cheese topping “thinning” problems. The optional addition of starch to a full fat cheese mass present in the cooker/stretcher after cooking but before rapidly cooling the cooked mass on a chill roll has been suggested in U.S. Pat. No. 6,475,538.

There is a need for an improved process for manufacturing mozzarella-type cheese products, especially reduced-fat or fat-free mozzarella-type cheese products, which are firmer, more homogenous, and have an improved mouthfeel, and thus are more attractive for direct consumption and/or pizza topping applications.

### SUMMARY OF THE INVENTION

The invention relates to an improved process of producing mozzarella-type cheese, including natural mozzarella cheese. The process starts with a liquid dairy substrate that is cultured and coagulated. The coagulated dairy substrate is cut, and the curds are separated from the whey and collected to form a base curd. The base curd is blended with an edible farinaceous material. The base curd/farinaceous material blend is then cooked in a cooker or cooker/stretcher (preferably a lay-down cooker). The cheese mass is then cooled to produce the mozzarella-type cheese.

The blending of the base curd with a farinaceous material prior to the cooking step beneficially increases the functionality of the mozzarella-type cheese. The farinaceous material preferably is in an edible dry particulate or a granular form, which is readily dispersible in the base curd material. The farinaceous material may be a starch or a flour. The farinaceous material may be selected from the group consisting of corn starch, corn flour, wheat flour, wheat starch, potato flour, potato starch, tapioca flour, tapioca starch, rice flour, rice starch, arrowroot starch, and combinations thereof. The farinaceous material is typically added at a level of about 0.5 to about 10 percent, particularly at a level of about 1 to about 8 percent, and more particularly at a level of about 2 to about 6 percent, of the finished mozzarella-type cheese product.

In one aspect, the farinaceous material, when blended with a reduced-fat or fat-free base curd prior to cooking/stretching, appears to act as a fat mimetic in the finished cheese product, thereby imparting a textural characteristic resembling a full fat product. For example, the mouthfeel of a reduced-fat or fat-free mozzarella-type cheese made by preblending the farinaceous material and base curd prior to cooking is comparable to similar cheeses made without the farinaceous material but having higher fat content. These textural enhancements in reduced-fat or fat-free mozzarella-type cheeses are obtained while providing suitable flavor and other organoleptic characteristics commonly associated with mozzarella-type cheeses. In one aspect, non- or low fat mozzarella-type cheese products made with the pre-blending of the farinaceous material with the base curd prior to cooking contain less than about 10 percent fat, particularly less than about 2.5 percent fat, and more particularly less than about 1 percent fat, are provided. The invention is also applicable to higher fat content cheese formulations including 2% fat cheeses (typically about 14 to 18 percent fat content) and full fat cheeses (e.g., greater than 20 percent fat content).

In another aspect, the blending of the farinaceous material with the base curd (e.g., low-fat content base curds) before cooking also improves moisture binding in the product and results in a firmer cheese which may be easier to shred. Additionally, the blending of the farinaceous material with the base curd before cooking produces a more homogenous finished cheese product. The mozzarella-type cheese products provided are not fibrous or rubbery in texture. Also, although the cooked product is cooled (e.g., brine cooling) after cooking, rapid cooling techniques, such as chill roller cooling, are not required to make the cheeses of the present invention.

The present process, therefore, generally produces a higher quality finished mozzarella-type cheese product and allows more production flexibility, even for reduced-fat or fat-free cheese formulations. The invention also relates to mozzarella-type cheese products manufactured by the process as described herein.

### BRIEF DESCRIPTION OF THE DRAWING

Other features and advantages of the invention will become apparent from the following detailed description of preferred embodiments of the invention with reference to the drawing, in which:

FIG. 1 is a schematic flow diagram generally depicting a process for making mozzarella-type cheese according to an embodiment of the present invention.

### DETAILED DESCRIPTION

Generally, in accordance with the present invention, stringy and rich melting natural cheese products, such as pasta filata type cheeses, are provided which have the firm textured functional body characteristics of a young mozzarella cheese. A fluid media is provided containing non-fat milk solids, and, if present, fat in significantly reduced amounts as compared to those used in conventional mozzarella manufacture. The fluid media may be standardized by addition of suitable amounts of a protein source, such as milk protein concentrate (MPC) and/or additional non-fat dairy ingredients such as non-fat dry milk (NFDM). Acidity is developed in the media which is set with rennet to provide a coagulum. The coagulum is then cut to provide curd and whey. The whey is drained from the base curd; this drained but unstandardized curd is held to develop a predetermined level of acidity (i.e., pH of about 5.0 to about 5.8). The resulting curd, if desired, can be washed with water and salted. This so-called base curd may be used immediately or frozen or refrigerated until needed. The fat content of the resulting curd will largely depend on the fat content of the starting fluid medium. Preferably, the resulting curd will have a fat content (on dry basis) of less than about 0.5 percent, moisture of about 45 to about 60 percent, salt of about 1.6 to about 1.8, and a pH of about 5.0 to about 5.4.

Once needed, the base curd (whether freshly made or stored) may be ground (if necessary or desired) and then is treated in a blender where it is mixed with dry additives including a farinaceous material. The base curd/farinaceous material blend is then cooked in a cooker or cooker/stretcher (preferably in a lay-down cooker) where flavors, water, and optionally salt are added after steam injection in which the water hydrates and aids blending of the ingredients. The molten cheese mass is then shaped or molded, and then cooled. In one aspect, the resulting mozzarella-type cheese has a fat content (on dry basis) of about 0 to about 45 percent, moisture of about 45 to about 60 percent, salt of about 1.5 to about 2.1 percent, and a pH of about 5.0 to about 5.4. Fat-free mozzarella-type cheese prepared by this invention will generally have a fat content (on dry basis) of about of less than about 1.5 percent, moisture of about 56 to about 60 percent, salt of about 1.6 to about 1.8 percent, and a pH of about 5.1 to about 5.3. Reduced fat mozzarella-type cheese prepared by this invention will generally have a fat content (on dry basis) of about 20 to about 30 percent, moisture of about 49 to about 53 percent, salt of about 1.6 to about 1.8 percent, and a pH of about 5.1 to about 5.3. Full fat mozzarella-type cheese prepared by this invention will generally have a fat content (on dry basis) of about of less than about 35 to about 45 percent, moisture of about 50 to about 55 percent, salt of about 1.6 to about 1.8 percent, and a pH of about 5.1 to about 5.3. The resulting mozzarella-type cheese generally may contain about 20 percent to about 30 percent protein, or other protein amounts compatible with the desired functionality and organoleptic properties.

Prior to the present invention, manufacturers of mozzarella cheese and/or manufacturers of process cheese and imitation cheese were limited in their ability to prepare reduced-fat, low-fat, or fat-free mozzarella cheeses which maintained organoleptic attributes (such as in texture, flavor, and color) comparable with the standard full fat product. The terms “reduced fat,” “low fat,” and “fat free,” as used herein, have the respective meanings as defined in the Federal Standards of Identity unless indicated otherwise. The present invention enables the manufacturer to produce varieties of mozzarella cheese and mozzarella-like products comparable to the desired organoleptic characteristics using significantly reduced fat or even fat-free content cheese formulations. For purposes of this invention, the “base curd” and/or the resulting mozzarella-type cheese can, but do not have to, meet the standards of identity for mozzarella cheese.

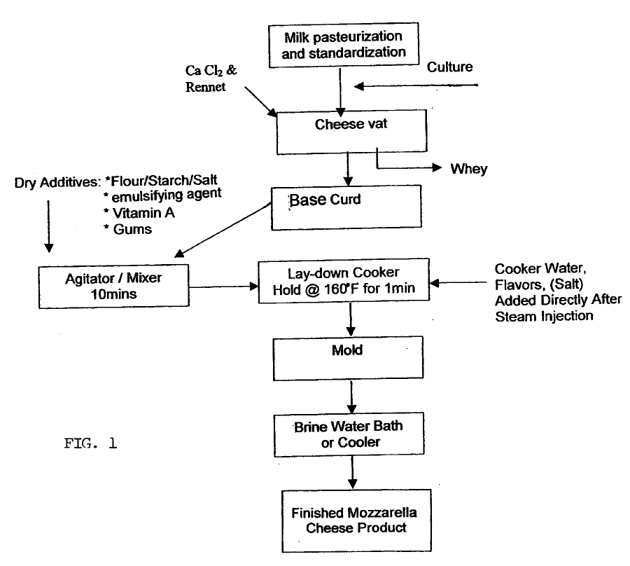

The general process of this invention is shown in FIG. 1. The preferred fluid media which is used to prepare the base curd contains non-fat milk solids and, if present, fat in significantly reduced amounts. In a preferred aspect, the fat content ranges is less than about 10 percent, particularly 0 to about 3 percent, and more particularly 0 to about 2.4 percent. The non-fat milk solids may be provided from whole milk, reconstituted dried non-fat milk solids, concentrated milk, skim milk, and the like as well as mixtures thereof. The fat, if present, may be milk fat, butter fat, cream, or other suitable fat-containing materials. The milk fat, if present, may be provided from whole milk or partially skimmed milk. The mozzarella-type cheese products prepared from this process may range from low moisture skim milk mozzarella to low moisture partially skim milk mozzarella to low moisture whole milk mozzarella. Milk protein concentrate (MPC) or other dairy protein source may be added, if desired, to adjust the protein level of the base curd and thus also the finished cheese product (e.g., to standardize the formulation). The overall protein content of the finished cheese generally may range from about 20 to about 30 percent.

Acidity is developed in the fluid media by the addition of a lactic-acid producing culture at a level of about 0.5 to about 1.5 percent. Examples of suitable lactic acid producing cultures include Streptococcus lactis, Lactococcus lactis, Lactobacillus, and the like; other conventional lactic acid producing cultures can be used. Generally cultures containing both mesophilic and thermophilic cultures are preferred; preferably the lactic acid-producing culture is selected from the group consisting of Streptococcus lactis, Lactococcus lactis, and mixtures thereof. The resulting mixture is allowed to ripen for approximately about 20 to about 40 minutes, and more preferably about 15 to about 30 minutes, at a temperature of about 88 to about 96° F. to obtain a pH of about 6.5 to about 7. Preferably the pH is developed to about 6.5 to about 6.8. A coagulating agent (e.g., rennet such as Chymosin generally at about 0.007 to about 0.014 percent) is used to form a coagulum; the mixture is permitted to set at about 88 to about 96° F. for about 20 to about 40 minutes, and more preferably at about 90 to about 94° F. for about 30 minutes.

The base curd may be calcium-fortified with a calcium source added during cheese culturing and coagulation, or at a suitable later stage of manufacture. For example, calcium chloride, calcium sulfate, calcium lactate, calcium phosphate, and the like, as well as mixtures thereof, may be added for this purpose. The amount can vary depending on the amount of calcium-enrichment desired, but generally is in the range of about 0.01 to about 5 percent based on the finished cheese product.

After coagulation, the coagulum is then cut and the temperature raised to about 90 to about 107° F. over a period of about 20 to 60 minutes, and preferably to about 98 to about 105° F. over a period of about 28 to about 32 minutes. After this cooking step, the curd is held at these elevated temperatures for about 5 to about 15 minutes, and more preferably for about 10 minutes. About 30 to about 40 percent of the whey is removed; the remaining curd and whey is agitated (generally for about 10 to about 30 minutes). At this time, the pH of the curd is between about 5.5 and about 6.2, and more preferably between about 5.7 and about 6. After the remaining whey is drained, the resulting curd (referred herein as “base curd”) can be stored for significant periods of time under proper conditions until needed for the production of the final mozzarella-type cheese. For example, a 2 percent fat base curd may be stored up to about 90 days under frozen conditions, and fat-free base curd may be stored up to about 70 days under refrigerated conditions (i.e., about 35 to about 45° F.). The base curd may be, and preferably is, immediately converted to the final product if desired. If the base curd is to be stored, it may be transferred to suitable containers (e.g., 500 pound barrels), preferably pressed at about 120 to about 140 psi vacuum for about 20 to about 60 seconds to help remove additional whey, and then sealed in order to further increase the shelf life.

To prepare the final cheese, the base curd is placed in a suitable blender; generally a ribbon or similar blender is preferred. If the base curd is used immediately after manufacture, the stirred or milled curd can be added directly to the blender; if used after storage (especially if pressed before storage), the base curd should be broken up using conventional techniques before or after being placed in the blender; generally, base curd particles of about 2 inches in diameter or less are acceptable. The farinaceous material is then added at levels of about 0.5 to about 10 percent, particularly about 1 to about 8 percent, and more particularly about 3 to about 6 percent, based on weight of the final cheese product. Other dry additives also may be added at this time, including salt, calcium, gums, hydrocolloids, particulates (e.g., condiments, dehydrated vegetables, spices), vitamins (e.g., vitamin A), and the like. The ingredients are blended at a temperature of about 35 to about 80° F. (preferably about 40 to about 72° F.) until thoroughly mixed (generally about 5 to about 30 minutes, particularly about 10 to about 15 minutes) to form a base curd/farinaceous material blend.

The farinaceous material can be in solid particulate form and does not need to be pre-mixed with water. Generally, the farinaceous material particles pass through a sieve having a mesh size of less than about 140 mesh, and preferably less than about 50 mesh. The starch or flour is typically added at a level of about 0.5 to about 10 percent, particularly at a level of about 1 to about 8 percent, and more particularly at a level of about 2 to about 6 percent, of the finished mozzarella-type cheese product. If the level of farinaceous material is too low (generally below about 1 percent), some leakage of whey may occur during cooking and/or the functional advantages of preblending the starch and curd base may not be fully achieved. Full incorporation of the starch material into the base curd may not be obtained if too much starch material (generally greater than about 6 percent) is introduced. Full incorporation of the starch also may be impacted by the moisture level of the base curd; generally the moisture content of the base curd should be about 45 to about 60 percent and preferably about 47 to about 57 percent. Also, if the pH of the curd is below 5, it may become more difficult to incorporate the starch material through preblending prior to the cooking step.

The farinaceous material may be selected from the group consisting of corn starch, corn flour, wheat flour, wheat starch, potato flour, potato starch, tapioca flour, tapioca starch, rice flour, rice starch, arrowroot starch, and combinations thereof. Flours or instant starches may be used. Rice flour is generally preferred for use in production of mozzarella-type cheese. The farinaceous ingredient has been observed to generally cause an increase in moisture content of the finished cheese product while maintaining the desired organoleptic properties in reduced-fat or fat-free cheese formulations.

In plants, starch is a reserve carbohydrate polymer, deposited as granules in the seeds, tubers or roots. In their native state, these starch granules differ in size, shape, amylose content, and gelatinization temperature, depending on the plant source. Native corn starches, for example, may be obtained from waxy maize corn starch or common corn starch. Native corn starch granules, for instance, are often approximately 15 microns in size and have round to polygonal shapes, although they are not limited thereto. Corn starch may be obtained by grinding the white hearts of corn kernels into a silken powder. Pregelatinized (pregel) starches are modified food starches which have been cooked, dried, and ground into power. They are referred to as “instantized” or instant starches in the food arts and for purposes herein. The results can be impacted by the starch particle size and distribution thereof. In general, finer starch particles work better than coarser starch particles. For example, long grain rice flour or rice fines can add an off flavor in the product and/or add black specks, and medium grain rice flour may not adequately perform functionally. In one aspect, the starch is a particulate having a sieve screen size of less than about 140 mesh and preferably less than about 50 mesh. Aqueous starch slurries, such as aqueous rice slurries, also may be used as the starch source and provide satisfactory functional results, but may be less desirable due to higher costs associated with their use.

Gums and/or stabilizers can be added to the cheese to bind water and help form the cheese body. Examples include carrageenan, gum arabic, xanthan gum, guar gum, pectin, and the like. The gum is preferably added in dry form, rather than pre-mixed with water. The total amount of gums added generally will be in the range of about 0.01 to about 10 percent, particularly about 0.01 to about 4 percent, based on finished cheese weight.

Salt may be introduced during the blending stage in amounts providing a salt content of about 1.5 to about 2.1 percent salt, preferably about 1.6 to about 1.8 percent, in the finished cheese product.

In order to prepare process cheeses using the methods of this invention, emulsifying agents may be introduced before or during cooking. Suitable emulsifying agents include, but are not limited to, anion sequestrants, especially cheese emulsifiers that sequester calcium ions in cheese. Calcium, sodium and sodium aluminum phosphate and citrate emulsifying agents are preferred. Examples of suitable emulsifying salts include tricalcium phosphate, sodium hexametaphosphate, monosodium phosphate, sodium tripolyphosphate, disodium phosphate, sodium citrate, and the like. The emulsifying salts may be added to the base curd in dry form. Generally, the emulsifying salts are used in an amount in the range of about 0.01 to about 2 percent based on the finished cheese weight.

The preblended base curd and farinaceous material is then introduced into a suitable cooker at a temperature of about 50 to about 70° F., preferably at about 55 to about 65° F., and cooked at about 155 to about 165° F. for about 0.5 to about 2 minutes, preferably at about 158 to about 162° F. for about 40 seconds to about 1.5 minutes. Preferably, a conventional direct steam injection lay-down cooker/stretcher is used. During or after cooking, water, flavors, salt, colorants, dairy proteins, and the like may be introduced to complete the cheese formulation. Dairy proteins may be added at about 0.1 to about 10 percent to increase the protein level of the resulting cheese.

Salt also may be added at the cooking stage to provide about 1.5 to about 2.1 percent salt, preferably about 1.6 to about 1.8 percent, in the final cheese product. Flavors can be added in effective amounts. The purpose of a flavor typically is to alter the flavor profile of the cheese in order to meet consumer preferences. Suitable flavors for mixing into the heated cheese include, for example, cheddar cheese flavor and parmesan cheese flavor. Typically, the flavor is added in an amount within the range of about 0.01 to about 5 percent based on the finished cheese weight. The flavor may be added in dry form or as an aqueous solution. Although not essential, known or suitable food grade colorants (e.g., tumeric, annatto) optionally may be added in amounts, such as less than about 2 percent, which adjust the appearance of the cheese product in a desirable manner without adversely impacting the functionality, texture, or taste thereof.

Water facilitates blending of the ingredients in the cooker. The amount of water added to the product through direct steam heating and/or process water adjustments in the cooker is generally between about 2 and about 8 percent of the total finished product. The remainder of the water content essentially is introduced as part of the base curd production. Water is added in an amount sufficient to provide a final product moisture content of between about 45 to about 60 percent, particularly about 52 to about 57 percent, in order to help achieve the desired functionality and organoleptic characteristics.

If desired, an edible acid (e.g., acetic acid, lactic acid, and the like) can be added to adjust the pH to about 5.0 to about 5.6, and preferably about 5.2 to about 5.4. A molten cheese product is provided at the conclusion of the cooking step.

The conditions in the cooker/stretcher should be carefully controlled to avoid local overheating. Thus, the mixing speed or mixing energy input should be relatively high during cooking. Using a steam injection cooker, the steam injection preferably is terminated when the cheese mass reaches a temperature in the range of about 155 to about 165° F. in order to avoid degradation. The steam pressure should be between about 30 and about 60 psi during the cook cycle. The total amount of water added to the finished product is contributed through both direct steam heating and process water adjustments in the cooker. A minimum hold time should be used in the cooker/stretcher at temperature allowing (a) formation of a stable cheese emulsion; (b) alignment of the protein in the cheese matrix to allow for stretchability in the finished product; and (c) destruction of vegetative pathogens. Generally, residence times greater than about 10 minutes and/or temperatures greater than about 170° F. should be avoided; otherwise the cheese mass tends to break down, thereby creating emulsion instability, which can lead to a “soupy” mixture in the cooker.

The molten cheese product from the cooker/stretcher is then molded or otherwise shaped. In one aspect, the molten cheese product is hot packed in appropriate containers, which then are cooled. The packaging imparts shape. Alternatively, the product may go to an extruder or molder where the melted cheese is augured into molds. The product cools in the molds so that it will retain the mold shape when the molded product is pushed out of the mold into salt brine. While the molded cheese product finishes cooling in the brine, salt from the brine soaks into the molded cheese product before packaging. In another alternative, the shaping comprises extruding the molten cheese product in rope form, and after the cooling, the cooled ropes are cut into discrete pieces.

Alternatively, the molten cheese mass discharged from the cooker could be transferred to a surge tank and then fed by gravity to a chill roll cooler. In that aspect, the molten cheese could be formed; for example, into sheets over ammonia-chilled rollers cooling the molten cheese a temperature of about 50 about 60° F. in less than about 4 minutes. The sheet of cheese can be cut into ribbons. The ribbons can be stacked, cut lengthwise, and placed in suitable containers (e.g., 500 pound barrels). Once the containers are full, the cheese is pressed and the containers sealed. The filled cheese containers are then placed in a suitable cooler in order to lower the overall cheese temperature to less than about 50° F. within 72 hours. The cheese may be stored at refrigerated or frozen temperatures until use.

In one preferred aspect, a reduced-fat or fat-free mozzarella-type cheese product is obtained which has a greatly improved texture which gives a much better mouthfeel and makes it much more attractive for direct consumption. It also is believed that the starch binds the moisture in the reduced-fat or no fat mozzarella-type cheese product, producing a firmer cheese which is easier to shred. The process of the invention is also applicable to higher fat content mozzarella-type cheese production, such as production of mozzarella-type cheeses containing greater than about 14 percent fat content, and even full fat cheeses containing at least about 20 percent fat.

Cheese shreds and cheese shred blends (i.e., the inventive mozzarella-type blended with other cheeses) have been evaluated for taste, texture, and other organoleptic properties. Additionally, evaluations have also been carried out using the inventive mozzarella-type cheese as a pizza topping. These tests demonstrate that full fat mozzarella-type cheese prepared by the present process is at least comparable to conventionally-made mozzarella cheese made without the starch additive and that reduced-fat mozzarella-type cheese prepared by the present process is superior to mozzarella cheeses made with starch added directly to the formed cheeses (i.e., added at a time after the cooking step). The reduced-fat mozzarella with starch also performed better in melt and stretch than conventional reduced fat mozzarella cheeses.

The Examples that follow are intended to illustrate, and not to limit, the invention. All percentages used herein are by weight, unless otherwise indicated.

### EXAMPLE 1

An experimental study was performed to investigate the affect on the functionality of 2 percent milk fat mozzarella-type cheese of preblending a starch material with the base curd before cooking in a laydown cooker as compared to its addition directly in the cooker. The 2 percent milk fat cheese had “reduced-fat” content as defined by the Federal Standards of Identity. A series of mozzarella-type cheese production runs were conducted using fluid media comprising non-fat dry milk (NFDM) and milk protein concentrate (MPC) as a substrate. A base curd was prepared by culturing and coagulating the substrate. A rice flour, as a starch material, was pre-blended with the base curd in some test runs, and directly added to the cheese curd in the cooker in another run.

Samples 1A to 4A involving preblending of the starch material with the base curd prior to cooking. In samples 1A to 3A, the rice flour (Rivland) level was varied from 1.9 to 5.7 percent; sample 4A used a modified or waxy starch (A&B Ingredients) at 5.7 percent in lieu of rice flour. In the comparison Sample C1, rice flour was added directly to the cooker in an amount of 5.7 percent; otherwise the control was prepared in a similar manner as samples 1A to 3A. Table 1 below summarizes the formulations used. Unless indicated otherwise, ingredient amounts are referenced to the finished product.

TABLE 1

| | | | | Product |
|---|---|---|---|---|
| | Starch | Starch | Starch Addition | Moisture |
| Sample | Material | (%) | Time | (%) |
| 1A | rice flour | 1.9 | preblended with base | 52 ± 1.5 |
| | | | curd, prior to cooker | |
| 2A | rice flour | 3.8 | preblended with base | 52 ± 1.5 |
| | | | curd, prior to cooker | |
| 3A | rice flour | 5.7 | preblended with base | 52 ± 1.5 |
| | | | curd, prior to cooker | |
| 4A | waxy starch | 5.7 | preblended with base | 52 ± 1.5 |
| | | | curd, prior to cooker | |
| C1 | rice flour | 5.7 | directly in cooker | 52 ± 1.5 |

For inventive samples 1A-4A and control sample C1, acidity was developed in the fluid media by the addition of a lactic-acid producing culture (Chris Hansen DVS) at a level of about 0.5 percent and the culture ripened for approximately 30 minutes, to a pH of about 6.5 to about 7. Sufficient double strength rennet was added to set the mixture in about 30 minutes. Calcium chloride was added as a calcium fortifier with the rennet addition in an amount of about 0.01 percent based on the finished product. The coagulum was then cut. The temperature was raised to between about 103 to about 107° F. over a period of 30 to 35 minutes and held at that temperature for about 30 minutes. About 30 to 40 percent of the whey was removed from the vat, and the remaining curd and whey was agitated in the vat for about 20 minutes. At this time, the pH of the curd was between about 5.7 and about 6. The resulting base curd was transferred to 45 pound crates; excess whey was allowed to drain. This curd is termed the “base curd.”

In samples 1A to 4A, the base curd was thoroughly mixed in a ribbon blender with the desired amount of starch material (see Table above) and 1.75 percent salt for about 10 to about 15 minutes. Control sample C1 was blended with the same dry additives, except that the starch was added at a later stage (i.e., during steam injection), at the same levels and conditions prior to cooking.

The blended base curds were delivered into a single-auger, direct steam injection lay-down cooker/stretcher. The blend was heated to a temperature of about 160° F. through direct steam injection over a period of about 2 to 4 minutes; additional cooker water was also added. The cook cycle was maintained at about 160° F. at about 60 psi for about 40 seconds to about 1.5 minutes. The total amount of water added to the product through direct steam heating and process water adjustments in the cooker was about 9 percent of the finished product. The auger in the cooker/stretcher was set at 95 to 105 rpm. The starch was added to the control sample during cooking (i.e., during steam injection). The molten cheese mass was downloaded from the cooker into 5 pound loaves and stored under refrigeration conditions. Alternatively, the molten cheese can be formed into other shapes and cooled using other conventional techniques (e.g., 1 pound balls cooled in brine for about 10 to about 30 minutes).

The texture and flavor of each product sample was evaluated. The inventive samples 1A-4A had superior functionality to control sample C1 in terms of shredability after storage for 30 to 90 days. Samples 1A-3A had the best functionality of the tested samples.

### EXAMPLE 2

Mozzarella-type cheeses (about 2 percent fat) were prepared using the same procedures as outlined in Example 1, except that the type of starch and amount of starch were varied in separate runs to assess their possible impact on the functional and organoleptic properties of the product. The starch additives for the inventive samples were introduced via preblending with the base curd prior to cooking. A conventional 2% mozzarella cheese (with no added starch) was used as the control (labeled C2).

TABLE 2

| Sample | Starch Material | Starch (%) | Product Moisture (%) |
|---|---|---|---|
| 1B | rice flour | 1.9 | 51 ± 2 |
| 2B | rice flour | 1.9 | 51 ± 2 |
| 3B | rice flour | 1.9 | 51 ± 2 |
| 4B | rice flour | 1.43 | 51 ± 2 |
| 5B | tapioca starch³ | 1.9 | 51 ± 2 |
| 6B | potato starch⁴ | 1.9 | 51 ± 2 |
| 7B | long grain rice flour⁵ | 5.7 | 51 ± 2 |
| 8B | medium grain rice flour⁶ | 5.7 | 51 ± 2 |
| 9B | rice flour | 3.8 | 51 ± 2 |
| 10B | rice fines⁷ | 3.8 | 51 ± 2 |
| C2 | none | 0 | 51 ± 2 |

³National
⁴Penford
⁵Rivland
⁶Rivland
⁷Kraft

The rice flour, tapioca flour, and potato starch blends provided adequate results with rice flour providing results with the best comparison to the control product. Cheese products prepared with the long grain rice flour and rice flour materials performed better than cheese products prepared with the medium grain rice flour. The cheese product made with the rice fines had an off flavor and black specks were observed in the product. Some whey was observed to leak during cooking at levels of rice flour below or at 1.9 percent, although meaningful functional benefits were nonetheless attained at 1.9 percent.

### EXAMPLE 3

Fat-free mozzarella-type cheeses were prepared using the same procedures as outlined in Example 1, except that the type of starch and the NFDM and MPC levels in the substrate were varied in separate runs to assess their possible impact on the functional and organoleptic properties of the product. The fat-free cheese samples had fat content meeting Federal Standards of Identity for “fat free.” The fat-free samples containing starch additive all had 1.9 percent starch introduced via preblending with the base curd prior to cooking. A fat-free control, C3, was prepared, which was similar to control C2 as described in Example 2, except that its fat content fell within Federal Standards of Identity for “fat free” designation. Table 3 below summarizes the formulations used.

TABLE 3

| | | | | | Product |
|---|---|---|---|---|---|
| | | Starch | NFDM | MPC | Moisture |
| Sample | Starch | (%) | (%) | (%) | (%) |
| 1C | rice flour | 1.9 | 0.42 | 0 | 60 ± 2 |
| 2C | rice flour | 1.9 | 0.92 | 2.52 | 60 ± 2 |
| 3C | rice flour | 1.9 | 1.94 | 5.05 | 60 ± 2 |
| 4C | tapioca flour | 1.9 | 0.42 | 0 | 60 ± 2 |
| C3 | none | 0 | 0.42 | 0 | 60 ± 2 |

Formulations 1C and 4C had the best functionality amongst the inventive samples and were comparable in functionality to the control sample C3.

### EXAMPLE 4

An experimental study was performed to investigate the affects of using stored base curd with various gums, flavors, gelatins, and starches. The formulations are shown in the Table below. The starch material was preblended with the stored base curd before incorporating into a laydown cooker. Eight production runs were conducted using the blended curd/starch material, the “other materials,” as well as salt, and water. The base curd was prepared according to the procedure outlined in Example 1 and was stored for two days in a cooler at 40° F. The rice flour was pre-blended with the stored base curd in all test runs. In Sample 1, some whey was observed to leak during cooking, but meaningful functional benefits were obtained in terms of product performance. Sample 2 had no “leakage” when cooking, and demonstrated excellent texture and mouthfeel. The rest of the batches all demonstrated good quality cheese when coming out of the cooker, with remarkable stretch and mouthfeel. Sample 5 was especially elastic in comparison to the rest. Samples 7 and 8 both demonstrate the benefits of incorporating flavors into the formulation to enhance the already acceptable tasting product with 5.7% rice flour. The entire test proved that using stored curd also produces a functional finished product, gums may be incorporated into the formula to enhance the already acceptable texture, and the product shows consistent performance when only rice flour is included in the formula.

| | Starch | | Other | | |
|---|---|---|---|---|---|
| | | Amount | | Amount | Product |
| Sample | Material | (%) | Material | (%) | Moisture (%) |
| 1 | Rice Flour^{a} | 3.8 | None | — | 53 ± 3 |
| 2 | Rice Flour | 5.7 | None | — | 53 ± 3 |
| 3 | Rice Flour | 3.8 | Modified | 1.9 | 53 ± 3 |
| | | | Cornstarch^{b} | | |
| 4 | Rice Flour | 3.8 | Gelatin 300^{c} | 1.9 | 53 ± 3 |
| 5 | Rice Flour | 3.8 | Gelatin 240^{d} | 1.9 | 53 ± 3 |
| 6 | Rice Flour | 5.6 | Carageenan^{e} | 1.9 | 53 ± 3 |
| 7 | Rice Flour | 5.7 | Flavor 1^{f} | 1.9 | 53 ± 3 |
| 8 | Rice Flour | 5.7 | Flavor 2^{g} | 0.5 | 53 ± 3 |
| Control^{h} | None | — | None | — | 53 ± 3 |

^{a}Rivland
^{b}National Starch and Chemical
^{c}Atlantic
^{d}Atlantic
^{e}FMC
^{f}Givaudan
^{g}Givaudan
^{h}Conventional mozzarella cheese

While the invention has been particularly described with specific reference to particular process and product embodiments, it will be appreciated that various alterations, modifications and adaptions may be based on the present disclosure, and are intended to be within the spirit and scope of the present invention as defined by the following claims.

What is claimed is:

1. A process for making mozzarella-type cheese, said process comprising:
(a) preparing a base curd;
(b) blending the base curd with an edible farinaceous material to provide a blended base curd containing at least about 0.5 percent edible farinaceous material;
(c) cooking the blended base curd to provide a molten cheese mass;
(d) shaping the molten cheese mass to provide a shaped cheese mass;
(e) cooling the shaped cheese mass to provide the mozzarella-type cheese.

2. The process of claim 1, wherein the edible farinaceous material comprises a starch material.

3. The process of claim 1, wherein the edible farinaceous material is selected from the group consisting of corn starch, corn flour, wheat flour, wheat starch, potato flour, potato starch, tapioca flour, tapioca starch, rice flour, rice starch, arrowroot starch, and combinations thereof.

4. The process of claim 1, wherein the edible farinaceous material comprises rice flour.

5. The process of claim 1, wherein the edible farinaceous material comprises corn starch.

6. The process of claim 1, wherein the edible farinaceous material is at a level of about 0.5 to about 10 percent in the mozzarella-type cheese.

7. The process of claim 1, wherein the edible farinaceous material is at a level of about 1 to about 8 percent in the mozzarella-type cheese.

8. The process of claim 1, wherein the edible farinaceous material is at a level of about 2 to about 6 percent in the mozzarella-type cheese.

9. The process of claim 1, wherein the mozzarella-type cheese comprises less than about 10 percent fat.

10. The process of claim 1, wherein the mozzarella-type cheese comprises less than about 2.5 percent fat.

11. The process of claim 1, wherein the mozzarella-type cheese comprises less than about 0.5 percent fat.

12. The process of claim 1, wherein the farinaceous material is substantially uniformly distributed material throughout the blended base curd.

13. The process of claim 1, wherein the shaping comprises molding and packaging the molten cheese product.

14. The process of claim 1, wherein the shaping comprises extruding the molten cheese product in rope form, and after the cooling, the cooled ropes are cut into discrete pieces.

15. The process of claim 1, wherein the base curd is prepared by a method comprising:
(1) culturing a liquid dairy substrate using a lactic acid-producing culture;
(2) coagulating the cultured liquid dairy substrate;
(3) cutting the coagulated dairy substrate to form curds and whey; and
(4) separating the curds and whey, and
(5) collecting curds to form the base curd.

16. The process of claim 1, wherein the cooking comprises heating and working the base curd blend in a cooker/stretcher at a temperature of about 155 to about 165° F. for about 30 seconds to about 2 minutes.

17. The process of claim 1, wherein the cooking comprises heating and working the base curd blend in the cooker/stretcher at a temperature of about 158 to about 162° F. for about 40 seconds to about 1.5 minute.

18. The process of claim 1, wherein the blending is performed using a ribbon blender.

19. The process of claim 1, wherein the cooking is performed using a direct steam injection lay-down cooker-stretcher.

20. A mozzarella-type cheese prepared by a process comprising (a) preparing a base curd; (b) blending the base curd with an edible farinaceous material to provide a blended base curd; (c) cooking the blended base curd in a cooker/stretcher to provide a molten cheese mass; (d) shaping the molten cheese mass to provide a shaped cheese mass; and (e) cooling the shaped cheese mass to provide the mozzarella-type cheese.

21. The mozzarella-type cheese of claim 20, wherein the edible farinaceous material comprises a starch or flour material.

22. The mozzarella-type cheese of claim 20, wherein the edible farinaceous material is selected from the group consisting of corn starch, corn flour, wheat flour, wheat starch, potato flour, potato starch, tapioca flour, tapioca starch, rice flour, rice starch, arrowroot starch, and combinations thereof.

22. The mozzarella-type cheese of claim 20, wherein the edible farinaceous material comprises rice flour.

23. The mozzarella-type cheese of claim 20, wherein the edible farinaceous material comprises corn starch.

24. The mozzarella-type cheese of claim 20, wherein the edible farinaceous material is at a level of about 0.5 to about 10 percent in the mozzarella-type cheese.

25. The mozzarella-type cheese of claim 20, wherein the edible farinaceous material is at a level of about 1 to about 8 percent in the mozzarella-type cheese.

26. The mozzarella-type cheese of claim 20, wherein the edible farinaceous material is at a level of about 2 to about 6 percent in the mozzarella-type cheese.

27. The mozzarella-type cheese of claim 20, wherein the mozzarella-type cheese comprises less than about 10 percent fat.

28. The mozzarella-type cheese of claim 20, wherein the mozzarella-type cheese comprises less than about 2.5 percent fat.

29. The mozzarella-type cheese of claim 20, wherein the mozzarella-type cheese comprises less than about 0.5 percent fat.

30. The mozzarella-type cheese of claim 20, wherein the mozzarella-type cheese comprises about 2 to about 4 percent protein.
